(19) United States
(12) Patent Application Publication
(10) Pub. No.: US 2008/0303665 A1
(43) Pub. Date: Dec. 11, 2008

(54) PACKAGE-COMPANION-USER INTERACTIVE SYSTEM AND ASSOCIATED METHOD

(75) Inventors: Praful Ramachandra Naik, Pune (IN); Mohan Harakachand Bhandari, Pune (IN); Jyoti Gopalkrishna Baliga, Pune (IN)

Correspondence Address: AKIN GUMP STRAUSS HAUER & FELD LLP, 1111 Louisiana Street, 44th Floor, Houston, TX, 77002, US

(73) Assignee: BILCARE, INC., Pune (IN)

(21) Appl. No.: 12/135,173

(22) Filed: Jun. 7, 2008

Related U.S. Application Data
(60) Provisional application No. 60/943,025, filed on Jun. 8, 2007.

(51) Int. Cl. G08B 23/00

(52) U.S. Cl. 340/568.1

(57) ABSTRACT

The present invention relates to a package-companion-user interactive system providing a comprehensive means of product authentication, registration for effective compliance, with user real-time feedback. The system comprises of a product package provided with a smart data processor and companion device comprising a housing with package holding provision; an array of signal generating means and signal sensing means provided in the said device to receive and reflect signals generated by the said signal generating means; user interactive means; powered time tracking means; data decoding means, data processing, data storage means, optionally equipped with audio visual display means, data transfer and connectivity means so configured to register user with the said device; authenticate product package, register product package, and optionally carrying out transient data collection and/or user feedback; when the said product package is placed in the said housing; wherein the product package is without any severable conductor.

### TECHNICAL FIELD

The invention relates in general to medicinal product packaging, and more particularly, to authentication of packaged medicinal products and monitoring packaged product usage.

### BACKGROUND ART

The handling, use and/or consumption of any product where multiple interests are concerned, for instance in healthcare management systems, creates complexity. The complexity increases with multiplicity of operations including handling, use or consumption of a product on an intermittent, regular or variable frequency basis. For effective use of a product, especially a pharmaceutical or medicinal product, a user requires the appropriate product and its usage related support, such as:

A way to establish the authenticity of the product with essential information about its manufacturer, date of manufacture, date of expiry, etc;

Basic product information and instructions for its effective use,

Prescription and dosage instructions, its recommended consumption frequency, and relevant precautionary measures if any;

A way of recording the product usage history for follow-up and support services; and

Timely on-line professional support when necessary.

Typically, recommended dosage and treatment protocols are specified for medicinal treatment products such as drugs, antibiotics, vitamins and supplements. Product related dosage and treatment protocol and safety information generally is printed on the product package or is printed on a sheet inside the package or both. In addition, product-identifying information such as date of manufacture, name of the manufacturer, expiry date, which can be used to authenticate a product, also may be provided on a product package or on a separate sheet accompanying the package.

Counterfeiting of medicinal products has become a widespread social menace. It has been estimated that 5-7% of world trade is in counterfeits, which is in the region of 250-350 billion dollars and is growing fast. In the period 1990-1995 world trade grew by 47% whereas in contrast, counterfeits grew by 150% (Briefing on Counterfeiting, AIM® Paper 1999). Initiatives have been undertaken to combat piracy of medicinal treatments through product authentication using security labels on the product or packaging, holographs on product packages, colored product packages, color-changing inks, and multi-color printing, for example. Nevertheless, product authentication to combat counterfeiting of medicinal treatments continues to be a challenge.

As the number and complexity of medicinal treatments and remediation has grown, a corresponding need has developed for improvements in management of product dosages and treatment protocols. Present day options available to the consumer include doctor or pharmacist prescriptions and basic information provided with over-the-counter products. Often, a user relies on his or her memory as to treatment protocol issues such as regard to the product dosage, usage conditions (e.g. with or without a meal) and frequency.

Changing life-styles such as greater personal mobility and a larger number of persons who receive treatments while living alone or away from families have resulted in an increased need for improved accessibility to assistance in the authentication and proper administration of medicinal products. Moreover, there has been an increased need for accurate consumer or patient feedback to manufacturers or researchers of a product that is under consumer or clinical trials in order to arrive at better understanding of product features and functions especially in terms of their effectiveness, side effects and efficacy of the medication, for example.

Providers of pharmaceutical products have desired a way whereby a user may provide or record feedback to healthcare professionals regarding consumption of a product or observations, for example as regards symptoms or side-effects, would allow for interactive treatment, authentication and also offer providers of pharmaceutical products an opportunity to gain feedback from consumers for use in clinical trials or pharmacovigilance.

Efforts have been made in the past to address some of the above needs. For example, U.S. Pat. No. 6,961,285 discloses a drug delivery management system to guide users or patients to take their medication and to assist third parties to collect information with regard to the patient medication intake. The system includes a portable medication monitor used in association with an instrumented medication package to provide intake data acquisition and patient support functions. The system may further be connected to a computer or computer network allowing information distribution between the medication monitor and third parties, such as physicians or pharmacists. The '285 Patent details a monitoring system for use in medication monitoring, which has medication packaged in a blister package format and in which the blister package can be used to monitor access to medication and to report such access to a separate monitor.

U.S. Pat. No. 5,412,372 discloses a portable medication dispenser aid that monitors dispensing times including regimen-conforming use of medications provided in blister packages. A blister package and a separate, disposable sensor sheet are loaded onto a compact housing containing supervisory electronics, visual indicators, and an audible alarm. The sensor sheet includes electrical or optical sensing regions corresponding to each individual compartment of the blister package. An electrically conductive or optical connector in the dispenser housing allows periodic scanning of the sensor sheet circuitry by the control circuitry in the dispenser housing without adding connector components to the disposable sensor sheet. When a medication is ejected through the backing layer of the standard blister package, an electrical or optical parameter associated with a corresponding region of the sensor sheet is altered, thereby permitting the control circuitry to monitor the dispensing event. Stored patient compliance data may then be reported remotely through an optical or electrical interface between the dispenser and an external system for review by a health care professional.

U.S. Pat. Nos. 6,839,304 and 6,411,567 describe a drug delivery management system for managing delivery of pharmaceutical drugs from a blister package that includes a plurality of cells arranged in a grid. Each of the cells is sealed by a breakable wall and holds a unit-dose of medication. A user gains access to the medication in a given cell by puncturing the breakable wall associated with the given cell. A severable conductor is positioned proximate to each breakable wall. The severable conductor associated with a given cell ruptures upon puncturing of the breakable wall associated with the given cell. A computer chip is electrically connected to the severable conductors. The computer chip senses the puncturing of each cell in the grid by monitoring the rupturing of each of the severable conductors. An RF transmitter is coupled to the computer chip. The RF transmitter sends information corresponding to usage of each of medications stored in the blister package to a remote information transceiver.

### SUMMARY OF INVENTION

In one embodiment, a system to regulate medicinal product consumption by an individual consumer comprises: a product package to contain a medicinal product, comprising a first data storage circuitry secured to the package and encoded with a first information; a companion device comprising one or more signal generators; one or more sensors to sense a signal generated by the one or more signal generators; a receptor region contoured to receive at least a portion of the product package and having the one or more signal generators and the one or more sensors disposed therewith; a reader configured to read the first information from the product package; a second data storage circuitry coupled to the reader and encoded with a second information; a processing circuitry associated with the reader configured to process the first information and the second information to authenticate the package.

In another embodiment, a package-companion-user interactive system comprises a product package, comprising a smart data processor affixed or embedded to the product package and encoded with a product package data using a unique identification protocol and further capable of storing a registration data corresponding to a user whereby the product package is configured for optional exclusive use by the user; a companion device comprising a housing with a package holding means; an array of signal generators; an array of corresponding signal sensors configured to receive signals generated by the array of signal generators; a user interactive and user input assembly including a display; a powered time tracker; a data decoding, processing and storage system configured to register a user, authenticate and register a product package when positioned with the housing, and optionally carry out one or more of transient data collection and user feedback, comprising: an authentication decoder configured to decode the encoded product authentication data; a memory configured to store: an accession time data entered by user through the input interactive and user input assembly regarding a desired accession time; a user registration data input through the user interactive and user input assembly; and a product package authentication data; a data processor configured to output a user signal with the user interactive and user input assembly to provide an indication to the user of the desired accession time; and a means for connecting the companion device to a service provider, wherein upon positioning of the product package with the companion device, the companion device interacts with the product package to authenticate the product package by: decoding the registration data and the product package data from the product package using the unique identification protocol; storing the decoded registration data and product data in the memory; matching the decoded registration data and product data with the stored user registration data and product authentication data; displaying a signal on the display to the user regarding authentication; displaying a signal on the display to the user regarding registration of the user; limiting access to the product package; and limiting access of the product package only to the companion device; and deactivating the registration of the package after a predetermined time, wherein the package and companion device interacts with user by: providing a signal to the user on the display for entering an accession data regarding a time of access; storing the accession data in the memory; displaying or providing a signal using the user interactive and user input assembly regarding accession of the product to provide an indication to the user; storing a data history of accession times of the product package; storing user feedback in the memory; and communicating information corresponding to the user through the means for connecting the companion device to a service provider.

In another embodiment, a package-companion-user interactive system comprises a product package comprising: a smart data processor; a companion device comprising: a housing with a package holding means; an array of signal generating means; an array of signal sensing means to receive and/or reflect signals generated by the signal generating means; a user interactive means; a powered time tracking means; a data decoding means; a data processing means; a data storage means; optionally equipped with an audio visual display means; and a data transfer and connectivity means configured to register a user with the device, authenticate the product package, register the product package, and optionally carrying out transient data collection and/or user feedback when the product package is placed in the housing.

In another embodiment, a method to monitor medicinal product consumption by an individual consumer comprises encoding an identification circuit on a medicinal product package with a first information; encoding data storage in a companion device with a second information; placing the medicinal product package and the companion device in close proximity; obtaining the first information from the identification circuit by the companion device; and processing the first information and the second information to authenticate the package to the companion device.

### BRIEF DESCRIPTION OF THE DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is an illustrative top view of a package monitoring device in accordance with some embodiments of the invention;

FIG. 2 is an illustrative front sectional view of the package monitoring device of FIG. 1;

FIG. 3 is an illustrative side view of a first package including a bottle shaped product container in accordance with some embodiments of the invention;

FIG. 4 is an illustrative perspective view of a second package including a pouch shaped product container in accordance with some embodiments of the invention; and

FIG. 5 is an illustrative top view of a third package including blister enclosures in accordance with some embodiments of the invention.

### DESCRIPTION OF EMBODIMENTS

The following description is presented to enable any person skilled in the art to make and use a system and method to facilitate authentication and safe usage of packaged medicinal treatments in accordance with embodiments of the invention. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

Applicant hereby incorporates by reference in its entirety for all purposes commonly owned U.S. Provisional Application No. 60/891,937, entitled “Interactive Smart Package-Associated Device for Anti-Counterfeit and Compliance Measures,” filed Feb. 22, 2007, as if expressly set forth herein.

Applicant hereby incorporates by reference in its entirety for all purposes commonly owned U.S. Provisional Application No. 60/943,025, entitled “Package-Companion-User Interactive System and Associated Method,” filed Jun. 8, 2007, as if expressly set forth herein.

While prior packages and systems to monitor use of medicinal products generally have been acceptable, there have been shortcomings with their use. For example, there has been a need for improvement in the authentication of medicinal treatment products particularly providing product information or user instructions for use. Moreover, there is a need for improvement in the availability of user feedback concerning usage of such products, for example. Provision for interaction with end user, authenticating the end user and providing user-friendly interactive input devices for the end user and communicating means to transmit the user based information to service providers are also short-comings in known systems. Known systems do not typically provide for deactivating package after the expiry date of the product to avoid misuse or wrong use.

The present invention aims to meet these needs by addressing the shortcomings of the prior art and provides a novel multidimensional package-companion-user interactive system that can be used effectively for any packaged product which is supported by a unique companion device system, which enables any user to orient the companion device exclusively and provide himself/herself with all the key features which would enable effective usage of the product along with the effective real-time capture of his/her feedback for own use or optionally for communicating the same for better management by the related service providers.

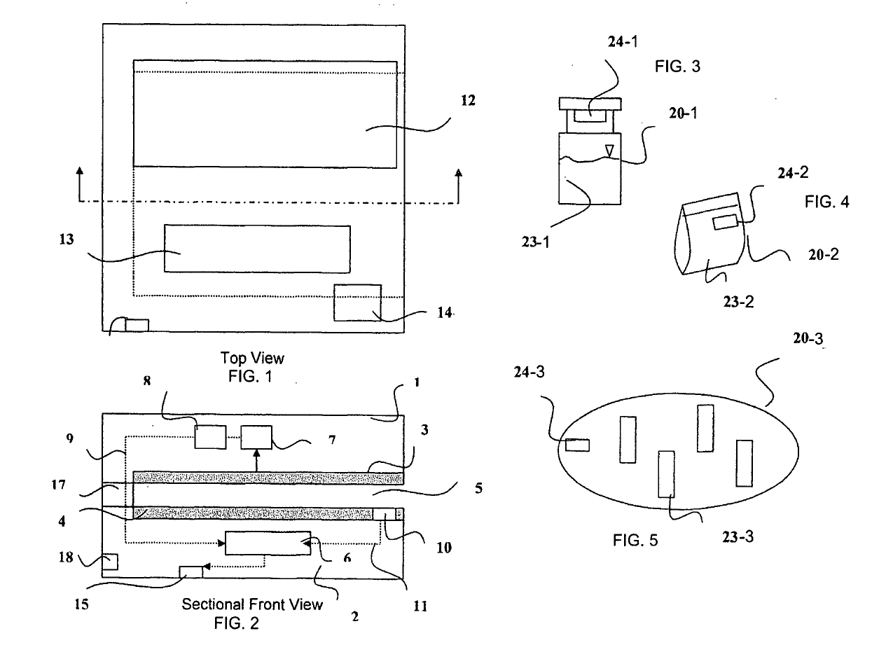

FIG. 1 is an illustrative top view of a companion device 100 for package monitoring in accordance with some embodiments of the invention. The monitoring device 100 includes a display region 12 such as an LED display, for example, to display an electronically generated message. The device 100 also includes a user input 13, such as keyboard buttons, for instance, by which a user may input information such as user-identifying information, for example. The device 100 further includes an interactive device 16 such as microphone and speaker, or a visual prompt such as a light, for example, to facilitate user registration with the device. The user interaction device 16 to provide an audible or visual prompt, for example, is linked to memory storage 8. Timely alarm on product accession is conveyed to the user in the form of a signal produced by the interaction device 16.

FIG. 2 is an illustrative front sectional view of the package monitoring device 100 of FIG. 1. The device 100 defines a reception region 5 (sometimes referred to herein as a receptor region) generally in the shape of a slot sized to receive at least a portion of one or more of the packages 24-1, 24-2, and 24-3 of FIGS. 3-5. The reception region 5 is disposed between opposed first and second members 1 and 2. One or more signal generators 3 are disposed upon the first member 1, and one or more sensors 4 are disposed upon the second member 2. The one or more signal generators 3 face the one or more sensors 4 on opposite sides of the reception region 5. More particularly, in one embodiment an array of signal generators 3 is disposed opposite and facing an array of signal sensors 4.

The device 100 includes a storage memory 8 operatively coupled to a real time measurement circuitry 7 and to a processing circuitry 6. An encoding/decoding access circuit 10 is disposed adjacent the reception region 5. A connector 15, such as a network adaptor, for example, provides connectivity to permit signals to be externally input to or output externally from the device 100. The dashed lines 9 and 11 indicate electrical coupling among various components of the device 100.

FIG. 3 is an illustrative drawing of a side view of a first package 20-1 including a bottle shaped product container 23-1 having an identification circuit 24-1 secured thereto in accordance with some embodiments of the invention. FIG. 4 is an illustrative perspective view of a second package 20-2 including a pouch shaped product container 23-2 and having an identification circuit 24-2 secured thereto in accordance with some embodiments of the invention. FIG. 5 is an illustrative top view of a third package 20-3 including blister-shaped product enclosures 23-3 and having an identification circuit 24-3 secured thereto in accordance with some embodiments of the invention.

The identification circuits 24-1, 24-2 and 24-3 include data storage circuitry, such as a smart chip processor, that is pre-encoded during packaging of the medicinal product, for example, with authentication information such as one or more of manufacturer source, date, batch of manufacture and information regarding the product, for example. In one embodiment, the manufacturer registers the product with a unique IMEI number. The companion device 100 will have the authenticated IMEI number stored in the memory 8. The IMEI number will then be stored on the package 20-1, 20-2, or 20-3 in the identification circuit 24-1, 24-2, or 24-3 using a unique protocol, such as an encryption algorithm that is associated with the identification circuit 24-1, 24-2, or 24-3, such that the product related data is securely encrypted and can be decrypted only by the receptor 17 in a secured manner.

In operation, a portion of a package 20-1, 20-2 or 20-3 is positioned adjacent the reception region 5 such that a corresponding pre-encoded identification circuit 24-1, 24-2 or 24-3 is disposed in electronic communication with the encoding access circuit 10. When the package 20-1, 20-2, or 20-3 is brought into proximity with the encoding access circuit 10, the encoding/decoding access circuit 10 acts as a reader, so that the first authentication information is obtained from the identification circuit 24-1, 24-2, or 24-3. The obtained first information is compared with a second authentication information stored in memory 8 to ascertain whether the package is authentic. Processing of the authentication information may be performed by the processing circuitry 6. In particular, the processor 6 may retrieve the second information stored in data storage 8 and compare the retrieved second information with the first information obtained by the identification circuit in order to ascertain whether the package 20-1, 20-2 or 20-3 is authentic. The processor 6 causes an appropriate message to be displayed on the display region 12. For instance, the message may indicate whether or not the package is authentic.

The placement of a package 20-1, 20-2 or 20-3 adjacent the reception region 5 permits interception of one or more signals generated from the one or more signal generators 3. A pattern of one or more generated signals actually sensed by one or more sensors 4 depends on the presence of or quantity of the product inside the package 20-1, 20-2 or 20-3. For instance, in some embodiments, the presence of product in a particular blister pack capsule 23-3 results in blocking of a generated signal from reaching a corresponding sensor 4, and the absence of a product from the same capsule 23-3 allows (does not block) transmission of such generated signal to a corresponding sensor 4. Moreover, the amount or volume of medicinal product (whether in solid or fluid form) in a bottle 20-1, pouch-type 20-2, or other style package may influence the sensed signal pattern.

The real time measurement circuitry 7 determines details concerning product accession with respect to time based upon the sensed pattern of signals when signals are generated. The measurement circuitry 7 forms a powered time tracker where events related to accessing or dispensing of product from the package 20-1, 20-2, or 20-3 is tracked in real time. For example, the measurement circuitry 7 may provide data storage indicative of how many medicinal capsules have been removed and when. Product accession information is stored in data storage memory 8. Further, data related to frequency of accession also may be stored in memory 8. In some embodiments, when all of the medicinal product capsules of a particular package 20-1. 20-2, or 20-3 have been removed, authentication associated with the identification circuit 24-1, 24-2, or 24-3 may be invalidated so that the circuit cannot be reused on a counterfeit package for example. Moreover, for example, product accession information may be reported over a network via connector 15 to a health care provider who is monitoring patient compliance or product usage.

The user interaction device 16 also is linked to the memory 8. A timely alarm on product accession is conveyed to the user in the form of a signal by user interaction device 16. Further, the end user can feed in data in regard to effects, symptoms, observations related to product accession via a user input 13 which also includes user identification mechanism for user registration. This user information also may be reported via connector 15 over a network to the health care provider. Memory 8 is connected to processing circuitry 6 through connector 9 to facilitate data processing. The processing unit 6 is further linked to connector 15. End user interactive audio/visual/biometrics device 14 is provided on the member 1 to facilitate registration of the user with the companion device 100. The receptor 17 is positioned in the proximity of the reception region 5 to facilitate data accession from the package 20-1, 20-2, or 20-3. A power source 18 comprises an uninterruptible power source for a real time clock device (not shown) along with a rechargeable battery.

As a further safety, a user may be required to enter authentication information via user input 13. Information input by the user may be compared with information stored in memory 8 to assess the identity of the user and to determine what package (or what type of package) is to be used by the user. Thus, in some embodiments, authentication information within the storage memory 8 is stored based upon authentication information within an identification circuit 24-1, 24-2, or 24-3 of a package 20-1, 20-2 or 20-3 authorized for use by a particular user.

The product package 20-1, 20-2, and 20-3 can be automatically deactivated by programming the identification circuit 24-1, 24-2, and 24-3 to deactivate the product package 20-1, 20-2, and 20-3 when all of the product in the product package 20-1, 20-2, and 20-3 has been used or exhausted or the expiry date of the product package 20-1, 20-2, and 20-3 occurs.

In one of the embodiments, members 1 and 2 are in the same plane but are below the reception region 5.

In yet another embodiment, reception region 5 is incorporated in-between member 1 and member 2.

In yet another embodiment, reception region 5 is incorporated perpendicular to member 1 and member 2.

In yet another embodiment, member 1 and member 2 are disposed obliquely to each other.

The processing unit 6 is integrated with the signal generator 3, signal sensor 4, user interactive device 16, real time measurement circuitry 7, data encoding/decoding access device 10, data storage device 8, audio/visual/biometrics device 14, and a data connector 15 that allows for data transfer and communications.

In another embodiment, reception region 5 allows locking and/or sensing the placement of the package 20-1, 20-2, or 20-3, further displaying a signal to prompt the user for a password. Once the package 20-1, 20-2, or 20-3 is positioned with the reception region 5, and aligned with the receptor 17, an LED blinks to indicate that the placement is correct and encoding/decoding access circuit 10 reads data from the identification circuit 24-1, 24-2, or 24-3 through the receptor 17 to the storage memory 8.

In yet another embodiment, the signal generator 3 is a light emitting diode (LED), preferably emitting white light.

In another embodiment, the signal generator 3 is an ultrasonic signal generating system.

In yet another embodiment, the signal generator 3 is a laser source or system.

In yet another embodiment, the signal generator 3 is a proximity sensor that detects the presence/absence of metal.

In another embodiment, the signal sensor 4 is a color sensor, a photo transistor, or a light intensity sensor.

In another embodiment, the signal sensor 4 is an ultrasonic sensor.

In another embodiment, the signal sensor 4 is Hall effect sensor or switch.

In another embodiment, the signal sensor 4 is a reed switch.

In another embodiment, the signal sensor 4 is a capacitance measurement system.

In yet another embodiment, the signal sensor 4 is a spring-loaded mechanical device.

In another embodiment, the signal sensor 4 is a strain gauge.

In another embodiment, user interactive input 13 is a touch screen device.

In another embodiment, user interactive input 13 is a keyboard.

In another embodiment, user interactive input 13 is a Braille compatible keyboard.

In another embodiment, user interactive input 13 is a voice recognition device.

In another embodiment, user interactive input 13 is a biometric system.

In another embodiment, user interactive input 13 is an audio and/or visual signal indicating system.

In another embodiment, user interactive input 13 is a vibration generating system.

In another embodiment, the encoding access circuit 10 is a contact type Electrically Erasable and Programmable Read Only Memory (EEPROM) memory.

In yet another variant of this embodiment, the encoding access circuit 10 is a contact type read/write secured memory.

In yet another variant of this embodiment, the encoding access circuit 10 is a contact type read/write crypto memory.

In yet another variant of this embodiment, the encoding access circuit 10 is a contact type read/write microcontroller or processor based smart chip with a customized operating system, such as a customized version of WINDOWS CE®, LINUX®, SYMBIAN®, etc. with a customized application layer and framework to fulfill the software requirements for the desired usage.

In yet another variant of this embodiment, the encoding access circuit 10 is a non-contact type read/write crypto memory.

In yet another variant of this embodiment, the encoding access circuit 10 is a non-contact type Electrically Erasable and Programmable Read Only Memory (EEPROM).

In yet another variant of this embodiment, encoding access circuit 10 is a non-contact type read/write secured memory.

In yet another variant of this embodiment, the encoding access circuit 10 is a non-contact type read/write microcontroller or processor-based smart chip with a customized operating system.

In yet another variant of this embodiment, the encoding access circuit 10 is a non-contact type read only RFID tag that provides a unique serial number memory read algorithm.

In yet another variant of this embodiment, the encoding access circuit 10 is a memory spot, such as a Hewlett-Packard paper label memory spot.

In yet another variant of this embodiment, the encoding access circuit 10 is a near field communication (NFC) type circuit.

In another embodiment, the real time measurement circuitry 7 provides a powered time tracking capability.

In another embodiment, data storage 8 includes a flash memory.

In yet another embodiment, data storage 8 includes a compact flash memory.

In yet another embodiment, data storage 8 includes one or more SD cards.

In yet another embodiment, data storage 8 includes one or more mini SD cards.

In yet another embodiment, data storage 8 includes one or more micro cards.

In yet another embodiment, data storage 8 includes one or more multimedia cards.

In another embodiment, the visual display 12 is an LED display.

In another embodiment, the visual display 12 is a monochrome graphical display.

In another embodiment, the visual display 12 is a colored display such as a VGA or QVGA TFT display.

In another embodiment, the visual display 12 includes an organic LED display.

In another embodiment, the visual display 12 includes a customized LCD display.

In another embodiment, the audio/visual/biometrics device 14 includes a speaker phone.

In another embodiment, the audio/visual/biometrics device 14 includes an earphone or a headphone.

In another embodiment, the audio/visual/biometrics device 14 includes a microphone.

In another embodiment, the audio/visual/biometrics device 14 includes a receiver.

In another embodiment, the audio/visual/biometrics device 14 includes a wireless head-set.

In another embodiment, the data connector 15 includes a serial port, such as an RS 232 port or UART.

In yet another embodiment, the data connector 15 includes a USB interface.

In yet another embodiment, the data connector 15 includes an infrared based system.

In yet another embodiment, the data connector 15 includes Bluetooth connectivity.

In yet another embodiment, the data connector 15 includes a ZIGBEE® control.

In yet another embodiment, the data connector 15 includes a FIREWIRE® or IEEE 1394 connector.

In yet another embodiment, the data connector 15 includes an Ethernet interface.

In yet another embodiment, the data connector 15 includes a WLAN (Wireless Local Area Network).

In yet another embodiment, the data connector 15 includes a GPRS or Edge interface.

In yet another embodiment, the data connector 15 includes a GSM interface.

In yet another embodiment, the data connector 15 includes a CDMA interface.

In some embodiments, the identification circuit 24-1, 24-2, or 24-3 can include a smart data processor.

In one embodiment, the smart data processor includes a contact type electrically Erasable and Programmable Read Only Memory (EEPROM).

In another embodiment, the smart data processor includes a contact type secured memory.

In another embodiment, the smart data processor includes a contact type crypto memory.

In another embodiment, the smart data processor includes a contact type microcontroller or processor-based smart chip with a customized operating system.

In another embodiment, the smart data processor includes a non-contact type crypto memory.

In another embodiment, the smart data processor includes a non-contact type Electrically Erasable and Programmable Read Only Memory (EEPROM).

In another embodiment, the smart data processor includes a non-contact type secured memory.

In another embodiment, the smart data processor includes a non-contact type microcontroller or processor based smart chip with a customized operating system.

In another embodiment, the smart data processor includes a non-contact type read only RFID tag that provides unique serial number.

In another embodiment, the smart data processor includes a memory spot such as HP paper label memory spot.

The companion device 100 facilitates authentication of the product package 20-1, 20-2, or 20-3 along with optional features of user feedback and transient data collection.

In one of the embodiments, the package 20-3 comprises a product containment portion or holding cavity formed or made using laminate or other material and an optional closure.

In one of the embodiments, the package 20-3 comprises components such as a mono- or multi-layered laminated structure or other material with one or more formed cavities or receptacles such as the blister-shaped product enclosures 23-3 for holding or containing product and a closure for the cavities or receptacles 23-3 in the form of lamina, layers, or sheets appropriately attached. The material of construction of the components (both cavity and closure) can be the same or different. The package 20-3 is fitted or attached with a device or other provision which may be press-fitted to the companion device while placing the package in the reception region 5 so that the package 20-3 is held or locked thereby, preventing dislodging while handling of the companion device and requiring external force for removal.

In yet another embodiment, the receptacle and/or closure 23-3 can be thermoformed and/or cold formed.

In yet another embodiment, the receptacle and/or closure 23-3 can be made by a process of wrapping using cold or hot seal techniques.

In another embodiment, the package 23-1, 23-2, or 23-3 is enclosed or contained or encased in another enclosure.

In another embodiment, the package 23-1 comprises a product containment or holding cavity in the form of a container and closure. A portion of the closure is of appropriate shape so that it can be press-fitted to the companion device 100 while placing the package 23-1 in the reception region 5 so that the package 23-1 gets locked thereby preventing dislodging while handling of the companion device 100 and requiring external force for removal.

In yet another embodiment, the package 20-2 comprises a product containment or holding cavity formed by a flexible laminate or other material wherein at least a part or portion of the same laminate or other material is sealed to form a pouch 23-2, wherein a portion of the pouch 23-2 optionally is provided with a gusset, shaping device, or stiffener so that it gives rigid structure which can be press fitted to the reception region 5 of the companion device 100.

In another embodiment, the pouch 23-2 is provided with a closure for repetitive access or opening and closing of the pouch 23-2.

In yet another embodiment, the package 20-1, 20-2, or 20-3 is provided with a device (not shown) comprising a speaker, a battery, an optional switch, and an audio signal generator to provide information on branding, product identity, etc.

In one of the embodiments, the identification circuit device 24-1, 24-2, or 24-3 includes a secured memory device or a microcontroller based memory chip.

In yet another embodiment, the identification circuit device 24-1, 24-2, or 24-3 includes an RFID device.

In another embodiment, the authentication is facilitated for both covert and overt identification systems by use of molecular markers or special ink markers.

In yet another embodiment, the authentication is facilitated by use of disorder technologies in the form of tags.

In one of the embodiments, the sensors 4 generate electrical signals such as current, voltage, capacitance, frequency etc.

In yet another embodiment, the sensors 4 convert light to voltage for detecting color changes in the package material on product accession.

In one of the embodiments, the sensors 4 generate optical signals.

In another embodiment, the sensors 4 are selected from spring loaded mechanical device or strain gauges.

In one of the embodiments, the user input 13 is selected from a touch screen device, keyboard, or Braille compatible keyboard.

In yet another embodiment, user interactive device 16 is a voice recognition device; biometrics system, an audio/visual signal indicating system, or a vibration generator.

In another embodiment, a chip is affixed to the package 20-1, 20-2, or 20-3 as the identification circuit 24-1, 24-2, or 24-3.

In yet another embodiment, power source 18 is a rechargeable battery.

In another embodiment, independent or matrix conductive systems are positioned, printed, or placed on the closure area of the receptacles of the package 20-1, 20-2, or 20-3.

In one of the embodiments, product containment portions and/or closure of the package 24-1, 24-2, and 24-3 are made up of polymers, metals, paper, or other environmentally friendly materials coated with peelable or heat sealable coatings made of various acrylic natural gum base or synthetic based coatings to ensure a sealed or hermetically sealed system compatible to external and environmental factors, or a combination thereof.

In another embodiment, the package 20-1, 20-2, and 20-3 is made from special packaging materials for providing a range of features and product related functional properties such as antimicrobial, preservation, change indication, barrier to moisture, light, UV or IR radiation, gases or selective barrier properties to moisture or gases which allow specific diffusion properties for product liberated moisture or gases.

In yet another embodiment, data in the processing unit 6 is modulated in a bit pattern such that it is suitable for wireless transmission, such as at 2.4 GHz by using Bluetooth or ZIGBEE®.

In another embodiment, data is processed in the processing unit 6 so that it can be transmitted to a standard call service provider using a modem connected to connector 15.

In yet another embodiment, the companion device 100 is configured with a customized Interactive Voice Response (IVR) connectivity subsystem (not shown) capable of:

converting data history from the data storage memory 8 compatible with an external IVR protocol;

connecting to the IVR system using the IVR protocol;

downloading of the converted data into the IVR system; and

establishing a communication link with various value-added service providers.

The synergistic combination of the companion device 100 comprising the user input 13 including user identification capabilities to facilitate user identification, the audio/visual/biometrics device 14 configured with the real time measurement circuitry 7, the data processing unit 6, the data storage memory 8, and the product package 20-1, 20-3, and 20-3 affixed with the pre-encoded smart chip 24-1, 24-2, and 24-3 when positioned in or on the companion device 100 facilitates authentication and registration of the product package 20-1, 20-3, and 20-3 with a facility to authenticate and register a plurality of the same product packages 20-1, 20-3, and 20-3 every time a new package of the same product is inserted or positioned in the companion device 100 after complete use or consumption of the product from the preceding package 20-1, 20-3, or 20-3 and without limitations on the packages 20-1, 20-3, and 20-3 in terms of their size, shape, or package materials and along with optional feedback and transient product accession data collection features provide the user a comprehensive means with ease of authentication and effective use of a product along with the capability of capturing real-time feedback more specifically related to facilitation of authentication and effective compliance by the user of a product ensuring the safety, quality, efficacy and potency of product with an effective feedback interaction between the user and the companion device 100 for further value added use of the captured feedback by related support services and service providers to the user.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

We claim:

1. A system to regulate medicinal product consumption by an individual consumer comprising:
a product package to contain a medicinal product, comprising
a first data storage circuitry secured to the package and encoded with a first information;
a companion device comprising:
one or more signal generators;
one or more sensors to sense a signal generated by the one or more signal generators;
a receptor region contoured to receive at least a portion of the product package and having the one or more signal generators and the one or more sensors disposed therewith;
a reader configured to read the first information from the product package;
a second data storage circuitry coupled to the reader and encoded with a second information;
a processing circuitry associated with the reader configured to process the first information and the second information to authenticate the package.

2. A package-companion-user interactive system comprising:
a product package, comprising:
a smart data processor affixed or embedded to the product package and encoded with a product package data using a unique identification protocol and further capable of storing a registration data corresponding to a user whereby the product package is configured for optional exclusive use by the user; a companion device comprising:
a housing with a package holding means;
an array of signal generators;
an array of corresponding signal sensors configured to receive signals generated by the array of signal generators;
a user interactive and user input assembly including a display;
a powered time tracker;
a data decoding, processing and storage system configured to register a user, authenticate and register a product package when positioned with the housing, and optionally carry out one or more of transient data collection and user feedback, comprising:
an authentication decoder configured to decode the encoded product authentication data;
a memory configured to store:
an accession time data entered by user through the input interactive and user input assembly regarding a desired accession time;
a user registration data input through the user interactive and user input assembly; and
a product package authentication data;
a data processor configured to output a user signal with the user interactive and user input assembly to provide an indication to the user of the desired accession time; and
a means for connecting the companion device to a service provider,
wherein upon positioning of the product package with the companion device, the companion device interacts with the product package to authenticate the product package by:
decoding the registration data and the product package data from the product package using the unique identification protocol;
storing the decoded registration data and product data in the memory;
matching the decoded registration data and product data with the stored user registration data and product authentication data;
displaying a signal on the display to the user regarding authentication;
displaying a signal on the display to the user regarding registration of the user;
limiting access to the product package; and
limiting access of the product package only to the companion device; and
deactivating the registration of the package after a predetermined time, wherein the package and companion device interacts with user by:
providing a signal to the user on the display for entering an accession data regarding a time of access;
storing the accession data in the memory;
displaying or providing a signal using the user interactive and user input assembly regarding accession of the product to provide an indication to the user;
storing a data history of accession times of the product package;
storing user feedback in the memory; and
communicating information corresponding to the user through the means for connecting the companion device to a service provider.

3. A package-companion-user interactive system comprising:
a product package comprising:
a smart data processor;
a companion device comprising:
a housing with a package holding means;
an array of signal generating means;
an array of signal sensing means to receive and/or reflect signals generated by the signal generating means;
a user interactive means;
a powered time tracking means;
a data decoding means;
a data processing means;
a data storage means;
optionally equipped with an audio visual display means; and
a data transfer and connectivity means configured to register a user with the device, authenticate the product package, register the product package, and optionally carrying out transient data collection and/or user feedback when the product package is placed in the housing.

4. The package-companion-user interactive system of claim 3, wherein the package further comprises a containment portion without any severable conductors.

5. The package-companion-user interactive system of claim 3, wherein the signal sensing means measures a time differential in terms of capacitance based on a current or voltage generated by the signal generating means.

6. The package-companion-user interactive system of claim 3,
wherein the signal generating means is a light emitting diode emitting preferably white light, and
wherein the signal sensing means is a color sensor.

7. The package-companion-user interactive system of claim 3, wherein the signal generating means of the companion device generates an optical signal.

8. The package-companion-user interactive system of claim 3, wherein the package housing has a package locking means.

9. The package-companion-user interactive system of claim 3, wherein the signal-sensing means is a spring-loaded mechanical device

10. The package-companion-user interactive system of claim 3, wherein the signal-sensing means is a strain gauge.

11. The package-companion-user interactive system of claim 3, wherein the user interactive means is a touch screen device.

12. The package-companion-user interactive system of claim 3, wherein the user interactive means is a keyboard.

13. The package-companion-user interactive system of claim 3, wherein the user interactive means is a Braille compatible keyboard.

14. The package-companion-user interactive system of claim 3, wherein the user interactive means is a voice recognition device.

15. The package-companion-user interactive system of claim 3, wherein the user interactive means is a biometric system.

16. The package-companion-user interactive system of claim 3, wherein the user interactive means is an audio and/or visual signal indicating system.

17. The package-companion-user interactive system of claim 3, wherein the user interactive means is a vibration generator.

18. The package-companion-user interactive system of claim 3, wherein the data processing means outputs information modulated in a bit pattern such that it is suitable for wireless transmission.

19. The package-companion-user interactive system of claim 3, wherein the data processing means transmits information using a modem.

20. The package-companion-user interactive system of claim 3, wherein the companion device further comprises:
a customized connectivity data processing means to enable real-time connectivity to an IVR system using an external IVR protocol for communication with a service provider.

21. The package-companion-user interactive system of claim 3, wherein the smart data processor is affixed to the product package.

22. The package-companion user interactive system of claim 3, wherein the product package further comprises a product containment portion constructed from a laminate material.

23. The package-companion user interactive system of claim 3, wherein the product package further comprises a product containment portion constructed from a polymeric material.

24. The package-companion user interactive system of claim 3, wherein the product package further comprises a product containment portion constructed from a multi-layered laminate material.

25. The package-companion user interactive system of claim 3, wherein the product package further comprises a product containment portion constructed from a combination of two or more of a laminate material, a polymeric material, and a multi-layered laminate material.

26. The package-companion-user interactive system of claim 3, wherein the product package is press-fittable to the companion device.

27. The package-companion-user interactive system of claim 3, wherein the product package further comprises:
a device configured to provide information regarding branding and product identity comprising:
a speaker,
a battery,
an optional switch; and
an audio signal generator.

28. The package-companion-user interactive system of claim 3, wherein the smart data processor of the product package is a crypto memory device.

29. The package-companion-user interactive system of claim 3, wherein the smart data processor of the product package is a secured memory device.

30. The package-companion-user interactive system of claim 3, wherein the smart data processor of the product package is a micro-controller based memory chip.

31. The package-companion-user interactive system of claim 3, wherein the smart processor is an RFID device.

32. The package-companion-user interactive system of claim 3, wherein user registration with the companion device is done by:
entering a user identifier information via the user interactive means;
storing the information in the data storage means; and
conveying user registration feedback using the user interactive means.

33. The package-companion-user interactive system of claim 3, wherein the companion device interacts with the product package to register and authenticate product package by:
positioning the product package with the companion device such that the data decoding means is in contact with the smart data processor;
decoding a pre-encoded product information from the smart data processor;
storing the decoded product information in the data storage means;
authenticating the decoded product information against a predetermined product information in the data processing means;
providing an authentication feedback to the user via the user interactive means.

34. The package-companion-user interactive system of claim 3, wherein the product package further comprises:
a product package data, comprising one or more of predetermined number of days, an expiry date, or a user-defined number of days,
wherein the product package data becomes inaccessible when the product package is expired, comprising:
decoding the product package data using the decoding means;
storing the product package data in the data storage means;
comparing the product package data against an expiration date calculated by the powered time tracker means;
disabling access to the product package data if the product package data exceeds the expiration date.

35. The package-companion-user interactive system of claim 3, wherein the companion device and the product package interact with the user to collect transient product accession information by:
prompting the user using a product accession protocol as per a prescription inputted by the user;
accessing the product from the package according to the product accession protocol by the user;
inserting the product package in the housing in the device;
sensing for product absence in the product package using the array of signal generating means and the array of signal sensing means;
recording an accession time using the powered time tracking means; and
storing the accession time in the data storage means.

36. The package-companion-user interactive system of claim 3, wherein the companion device interact with user to collect and store real time user feedback by:
prompting the user to input feedback information regarding symptoms and effects of the product via the user interactive means;
storing the user feedback information in the data storage means; and
communicating the user feedback information through the data transfer and connectivity means to a service provider.

37. A method to monitor medicinal product consumption by an individual consumer comprising:
encoding an identification circuit on a medicinal product package with a first information;
encoding data storage in a companion device with a second information;
placing the medicinal product package and the companion device in close proximity;
obtaining the first information from the identification circuit by the companion device; and
processing the first information and the second information to authenticate the package to the companion device.

38. The method of claim 37, further comprising:
generating one or more signals by signal generators disposed on the companion device with the package in close proximity to the companion device;
sensing a portion of the generated one or more signals received by one or more sensors disposed on the companion device; and
based upon the sensed portion, determining the presence or absence or amount of one or more medicinal product items from the package; and
reporting such presence, absence or amount to the individual consumer or to a health care provider.
